(19) United States
(12) Patent Application Publication
(10) Pub. No.: US 2003/0118897 A1
(43) Pub. Date: Jun. 26, 2003

(54) Solid electrolyte cell and production method thereof

(76) Inventors: Shinji Mino, Ibaraki-shi (JP); Kazuya Iwamoto, Sakai-shi (JP); Shigeyuki Unoki, Katano-shi (JP); Hironori Ishii, Hirakata-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/276,665

(22) PCT Filed: Feb. 12, 2002
(86) PCT No.: PCT/JP02/01163

(30) Foreign Application Priority Data
Feb. 15, 2001 (JP) 2001-038561

(51) Int. Cl. H01M 2/02; H01M 4/64; H01M 10/36; H01M 10/38

(52) U.S. Cl. 429/149; 429/234; 429/304; 29/623.3; 29/623.5; 429/176; 429/178

(57) ABSTRACT

A solid electrolyte battery produced by a recessed portion forming step of forming a recessed portion 10 having a predetermined shape and a predetermined depth at a predetermined position on a substrate a1 and by a laminating step of laminating the layers of a power-generating element f on the recessed portion 10. With this configuration, the height of portions projecting from the surface of the substrate can be limited significantly, and the step coverage on the upper layer can be improved, whereby it is possible to produce a solid electrolyte secondary battery being excellent in reliability.

### DESCRIPTION

Solid electrolyte battery and method of producing the same

### TECHNICAL FIELD

The present invention relates to primary and secondary solid electrolyte batteries comprising a solid electrolyte and being characterized by high reliability, low profile, compact size and high capacity, and to a method of producing the same.

### BACKGROUND ART

As electronic and electrical apparatuses are made more compact and lighter, batteries are also requested to be made more compact and lighter. In response to this request, a lithium-ion secondary battery comprising a negative electrode made of a carbon material, a positive electrode made of lithium cobalt oxide and an electrolyte in which a lithium salt is dissolved in a non-aqueous solvent is used in large quantity. Various methods have been proposed as methods of producing the battery; however, a production method comprising a step of applying each of a positive electrode material, a negative electrode material and a separator material in a paste state and drying them, a step of cutting them into predetermined shapes, a pressure application step, a thermocompressing or overlaying and winding step, a step of adding an electrolyte or a polyelectrolyte is used mainly, and has become practical.

However, these steps have limitations in making batteries low-profile and compact. Hence, low-profile solid electrolyte secondary batteries have been devised by using a solid electrolyte and by introducing a semiconductor process and a patterning method. For example, these are disclosed in U.S. Pat. No. 5,597,660, U.S. Pat. No. 5,512,147, Japanese Patent No. Sho 61-165965, Japanese Laid-open Patent Application No. Hei 6-153412, Japanese Laid-open Patent Application No. Hei 10-284130, Japanese Laid-open Patent Application No. 2000-106366, etc.

However, each of the batteries comprises multilayers on a flat substrate; when each layer of the power-generating element is made thicker to increase capacity, surface steps becomes larger, and the step coverage on the metal wires disposed thereon and on the passivation protective film becomes defective, resulting in an unreliable battery.

On the other hand, film forming by the CVD (Chemical Vapor Deposition) method is excellent in step coverage; however, the substrate is subjected to high temperature, whereby the battery is damaged; therefore, this method is not suited for film forming after the formation of the power-generating element.

### DISCLOSURE OF THE INVENTION

The present invention proposes a solid electrolyte battery that can solve the above-mentioned problems and can be made compact and low-profile and is excellent in reliability, and also proposes a method of producing the battery.

The present invention is intended to provide a highly reliable solid electrolyte battery being excellent in step coverage on a surface insulating film and at a current delivery terminal portion connected to an upper metal current collector film by forming a recessed portion in a substrate and by configuring a battery thereon so as to obtain a multilayer battery having small surface steps, and also intended to provide a method of producing the battery.

In order to attain the above-mentioned objects, in the present invention, a recessed-portion having a predetermined shape and a predetermined depth is formed at a predetermined position in one of a semiconductor substrate (for example, silicon, GaAs, InP, GaN, SiGe, etc.), a glass substrate, a ceramic substrate, a resin substrate and a metal substrate, and a power-generating element comprising a lower metal current collector layer (in the case of the metal substrate, the substrate itself serves as a current collector) having a shape similar to that of the recessed portion and connected to a current delivery terminal portion, a first active material layer, a solid electrolyte layer, a second active material layer and an upper metal current collector film is laminated in multilayers on the recessed portion. Hence, solid electrolyte batteries including solid electrolyte primary and secondary batteries having been improved in step coverage and the method of producing them are obtained.

It is desirable that the depth of this recessed portion is in the range of 0.3 to 1.0 time as large as the whole film thickness of the power-generating element (the thickness from the lower metal current collector layer to the bottom of the upper metal current collector film) from the viewpoint of step coverage, and it is also desirable that the steps of projection portions from the surface of the substrate are about 0.6 μm or less; it is thus possible to provide a solid electrolyte battery having smaller steps and higher reliability in comparison with the conventional batteries.

The configuration of the battery differs depending on the substrate material to be used; in the case of a metal substrate, the substrate itself can be used as a lower current collector); after portions other than the formed recessed portion and a current delivery window formed away from the recessed portion (the window may be formed on the back face or a side face of the substrate) are coated with an insulating film, a power-generating element comprising a first active material layer, a solid electrolyte layer, a second active material layer and an upper metal current collector film (preferably connected to a current delivery terminal) is laminated and formed on the recessed portion.

In the case when the substrate is one of a semiconductor substrate, a glass substrate, a ceramic substrate and a resin substrate, a power-generating element comprising a lower metal current collector film connected to a current delivery terminal portion, a first active material layer, a solid electrolyte layer, a second active material layer and an upper metal current collector film (preferably connected to a current delivery terminal) is laminated and formed on the formed recessed portion.

In addition, in the case when the substrate is a semiconductor substrate or a resin substrate, after an insulating film is provided on the substrate to provide electrical insulation or to shut off moisture, a power-generating element comprising a lower metal current collector film, a first active material layer, a solid electrolyte layer, a second active material layer and an upper metal current collector film (preferably connected to a current delivery terminal) is formed on the recessed portion.

Although current may be delivered directly from the upper metal current collector film, it is preferable to provide a current delivery terminal portion, since the power-generating element is not damaged by stress during lead wire installation. Furthermore, the upper metal current collector film is coated with an insulating film, such as an insulating film made of a ceramic material, and/or a resin (a thermosetting resin or a photocuring resin; this is effective to shut off moisture and to protect the battery against mechanical breakage.

In the case when the substrate is a metal substrate, the substrate itself can be used as a current collector; even when the recessed portion is deep, the current delivery terminal portion of the upper metal collector film and the insulating film thereon can be formed with small steps by forming the negative electrode, the solid electrolyte and the positive electrode inside the recessed portion, thereby being advantageous.

Moreover, the side wall of the recessed portion or the side wall of the current delivery terminal portion located on the recessed portion side and connected to the lower metal current collector film is coated with an insulating film; this is effective to prevent short-circuit to the upper current delivery terminal portion.

The production method comprises a recessed portion forming step of forming a recessed portion having a predetermined shape and a predetermined depth at a predetermined position on the substrate and a laminating step of sequentially laminating a power-generating element on the recessed portion. As a recessed portion forming method, a machining method is used, or a dry-etching method or a wet-etching method wherein, after portions other than a recessed-portion forming portion are coated with a photoresist by the photo-lithography method, the metal substrate is etched to a predetermined depth by the dry-etching method or the wet-etching method, and the photoresist is removed to form a recessed portion is suitably used. As the machining method, milling and sandblasting are available and effective in forming a recessed portion having a depth of 10 μm or more. In the wet-etching method, an alkaline aqueous solution, such as sodium hydroxide (NaOH) and potassium hydroxide (KOH), or a hydrofluoric acid aqueous solution is effective for a silicon substrate; a hydrofluoric acid aqueous solution is effective for glass and ceramic substrates; a strong acid aqueous solution, such as hydrochloric acid (HCL) or nitric acid (HNO₃), or a strong alkaline aqueous solution, such as sodium hydroxide (NaOH) and potassium hydroxide (KOH), can be used for a metal substrate and is effective in forming a recessed portion having a depth of 0.1 μm to 10 μm. In addition, it is effective to use a method wherein portions other than a recessed-portion forming portion on a metal substrate is coated with a resin or the like, and electrolytic etching is carried out in an electrolytic solution by using the metal substrate as the anode. Furthermore, as the dry-etching method, a method (reactive ion etching method) wherein etching is carried out by reacting the plasma of CF₄, Cl₂ or the like with the substrate material, a RF plasma etching method wherein physical cutting is carried out by using argon plasma, and the like are available, and suited for forming a recessed portion having a depth of 0.1 μm to several μm.

The laminating step differs depending on the type of substrate; in the case of a metal substrate, the substrate itself can be used as the lower current collector; the production method comprises a step of forming a recessed portion having a predetermined shape and a predetermined depth at a predetermined position by one of the above-mentioned methods, and a laminating step wherein an insulating film is formed on the substrate by one of film forming methods selected from the evaporation method, the sputtering method and the CVD method; the insulating film on portions other than the bottom face of the recessed portion and a current delivery window forming portion is coated with a photoresist by the photo-lithography method; the insulating film on the bottom face of the recessed portion and the current delivery window is removed by the dry-etching method or the wet-etching method; the photoresist on the insulating film is removed to form an insulating layer; a first active material layer, a solid electrolyte layer and a second active material layer are formed on the recessed portion by one of film forming methods selected from the evaporation method and the sputtering method, and the patterning method by the dry-etching method after photoresist coating; a metal film is formed thereon by one of the film forming methods selected from the evaporation method, the sputtering method and the CVD method; and an upper metal current collector film is formed on the second active material layer by photoresist coating and dry-etching.

In the case when the substrate is one of a semiconductor substrate (having a high electrical resistance), a glass substrate, a ceramic substrate and a resin substrate, a step is carried out to form a recessed portion having a predetermined shape and a predetermined depth at a predetermined position on the substrate just as described above; furthermore, a metal film is formed thereon by one of film forming methods selected from the evaporation method, the sputtering method and the CVD method; the bottom face of the recessed portion and the current delivery terminal portions on this metal film are coated with a photoresist; and unnecessary portions are removed by the dry-etching method or the wet-etching method to form a lower metal current collector film connected to the current delivery terminal portion. Next, a laminating step is carried out; that is, the respective layers of a power-generating element are formed on this lower metal current collector film by one of methods selected from the evaporation method and the sputtering method; the first active material layer, solid electrolyte layer and second active material layer are formed by photoresist coating and the dry-etching method; a metal film is formed thereon by one of film forming methods selected from the evaporation method, the sputtering method and the CVD method; and an upper metal current collector film is formed by photoresist coating and the dry-etching method. In the case when the substrate is a semiconductor substrate (having a high electrical resistance) or a resin substrate, a step is carried out to form a recessed portion having a predetermined shape and a predetermined depth at a predetermined position on the substrate just as described above; furthermore, an insulating film is formed on the whole face of the substrate thereon by one of film forming methods selected from the evaporation method, the sputtering method and the CVD method; a metal film is formed by one of film forming methods selected from the evaporation method, the sputtering method and the CVD method; the bottom face of the recessed portion and the current delivery terminal portion on this metal film are coated with a photoresist; and unnecessary portions are removed by the dry-etching method or the wet-etching method to form a lower metal current collector film connected to the current delivery terminal portion. Next, a laminating step is carried out; that is, the respective layers of a power-generating element are formed on this lower metal current collector film by one of methods selected from the evaporation method and the sputtering method; the first active material layer, the solid electrolyte layer and the second active material layer are formed by the above-mentioned photoresist coating and the dry-etching method; a metal current collector film is formed thereon by one of film forming methods selected from the evaporation-method, the sputtering method and the CVD method; and an upper metal current collector film is formed by the above-mentioned photoresist coating and the dry-etching method.

Furthermore, when an insulating film is formed on the substrate, such as a metal substrate, a metal sheet or a resin film is stuck to the bottom face of the recessed portion and the current delivery terminal portions, an insulating film is formed by one of film forming methods selected from the evaporation method, the sputtering method and the CVD method, and the metal sheet or the resin film is removed, thereby being able to form the insulating film.

Still further, in the above-mentioned laminating step, the first active material layer and/or the second active material layer and/or the solid electrolyte layer can also be formed by a printing method, such as the screen printing method or the intaglio printing method, or by a filling method using a doctor blade.

The evaporation method herein includes the resistance heating evaporation method, the electron beam evaporation method, the DC ion plating method, etc., and the sputtering method includes the DC sputtering method, the magnetron sputtering method, ion beam sputtering method, etc.

The CVD method includes the thermal CVD method, the plasma CVD method, the photo-assisted CVD method, etc. and is excellent in step coverage; however, since the substrate is exposed to high temperature (250° C.), there is a danger of damaging the power-generating element.

In addition, coating is made possible by applying a resin to the current delivery terminal portion connected to the lower metal current collector and disposed on the side wall of the recessed portion of the substrate, such as a semiconductor substrate, a glass substrate, a ceramic substrate or a resin substrate, or by forming a ceramic insulating film by the evaporation method, the sputtering method or the CVD method and by patterning.

The step can be simplified and film deterioration can be prevented by carried out patterning after a plurality of layers are made continuously in the same chamber, instead of carried out film forming and patterning for each layer.

In the patterning method using a photoresist, an alkaline aqueous solution is used during development; hence, deterioration occurs depending on the material (Li alloy or the like) to be used. Therefore, when carrying out film forming on the substrate, by placing a metal mask having windows at necessary portions and by carried out film forming, damage to the material during patterning can be prevented. However, it is difficult to form fine patterns (about 1 mm or less) by the masking method.

The solid electrolyte battery can be directly formed on a semiconductor substrate and can also be mounted on a PC board by the COB (Chip On Board) method by forming bumps, such as metal bumps, on the current delivery terminal portions.

In the present invention, by having the configuration wherein the recessed portion is provided in the substrate and the layers of the power-generating element are laminated on the recessed portion as described above, steps on the surface of the substrate can be made smaller significantly, whereby wire breakage at the current delivery terminal portion connected from the upper metal collector film and breakage at the insulating film thereon can be prevented, whereby the reliability of the battery can be improved significantly.

In addition, the production method of the present invention comprises a recessed portion forming step of forming a recessed portion in one of a semiconductor substrate, a glass substrate, a ceramic substrate, a resin substrate and a metal substrate by the machining method, the dry-etching method or the wet-etching method, and a laminating step of forming (an insulating film, a lower metal current collector layer), a first active material layer, a solid electrolyte layer, a second active material layer or an upper metal current collector film by the application method, the evaporation method, the sputtering method or the CVD method (including a patterning step). These steps are similar to those in a semiconductor production process; however, since the CVD method being excellent in step coverage is difficult to use after the step of forming the second active material layer because the substrate is exposed to high temperature. Furthermore, since some of Li compounds are susceptible to moisture, patterning using a metal mask in the patterning step is effective. In the case when a metal substrate, such as a substrate made of copper (Cu) or aluminum (Al), is used, the substrate itself can be used as a current collector, and by coating the substrate surface other than the bottom face of the recessed portion and the current delivery terminal window and by also coating the side walls of the recessed portion with an insulating film, it is possible to form a battery having a deep recessed portion, whereby high capacity can be attained.

As the solid electrolyte material to be used herein, a lithium ion conductor, a copper ion conductor, a silver ion conductor and a proton conductor can be used. As the positive-electrode active material for the lithium ion conductor, LiₓCoO₂, LiₓNiO₂, LiₓMn₂O₄, LiₓTiS₂, LiₓMoS₂, LiMoO₂, LiₓV₂O₅, Li_{3/4}Ti_{5/3}O₄, Li₂₋ₓCoₓN, etc. were effective. On the other hand, as the negative-electrode active material, metal Li, Li alloys, such as LiAl, carbon materials, such as carbon and graphite, and alloys, such as FeSn and TiSn, were effective. As the lithium ion conductor, Li₂S—SiS₂, Li₃PO₄—Li₂S—SiS₂, LiI—Li₂S—SiS₂, LiI, LiI—Al₂O₃, Li₃N, Li₃N—LiI—LiOH, Li₂O—SiO₂, Li₂O—B₂O₃, LiI—Li₂S—P₂O₅, LiI—Li₂S—B₂S₃, Li_{3.6}Si_{0.6}P_{0.4}O₄, LiI—Li₃PO₄—P₂S₅, LiₓPO_{y}N_{z}, etc. can be used. Furthermore, in the case when the copper ion conductor was used for the solid electrolyte, as the active material, metal Cu, Cu₂S, CuₓTiS₂, Cu₂Mo₆S_{7.8}, etc. can be used; as the copper ion conductor, RbCu₄I_{1.5}Cl_{3.5}, CuI—Cu₂O—MoO₃, Rb₄Cu₁₆I₇Cl₁₃, etc. can be used. Furthermore, in the case when the solid electrolyte is the silver ion conductor, metal Ag, Ag_{0.7}V₂O₅, AgₓTiS₂, etc. can be used; as the silver ion conductor, α-AgI, Ag₆I₄WO₄, C₆H₅NHAg₅I₆, AgI—Ag₂O—MoO₃, AgI—Ag₂O—B₂O₃, AgI—Ag₂O—V₂O₅, etc. can be used.

Since a solid electrolyte battery is configured by laminating the layers of a power-generating element on a substrate having a recessed portion as described above in the present invention, portions projecting to the surface of the substrate are made smaller, and step coverage becomes excellent, whereby it is possible to form a solid electrolyte battery without subjecting the battery to high temperature that is required for the CVD method. In addition, in the case when increasing the capacity by making the layers of the power-generating element thicker, it is possible to configure a battery without forming large steps. This solid electrolyte battery is low-profile and compact, and excellent in safety and reliability, and can be attained as an on-chip battery. As a result, the problem of power source noise becomes insignificant, and countermeasures for high-frequency power sources, such as capacitor installation and wire routing, can be taken easily. Furthermore, a battery can be formed in a small no-wiring area of an IC, thereby greatly contributing to making electronic apparatuses with ICs compact and low-profile.

### BRIEF DESCRIPTION OF THE DRAWINGS

FIGS. 1 to 5 are sectional views showing processes of forming a recessed portion in a substrate in the production processes of a solid electrolyte secondary battery in accordance with Embodiment 1 of the present invention;

FIGS. 6 to 9 are sectional views showing processes of forming a power-generating element;

FIGS. 10 to 12 are sectional views showing processes of forming a protective film and current delivery terminal portions;

FIG. 13 is a sectional view at the time when a plurality of batteries are produced on the substrate;

FIG. 14 is a sectional view of a solid electrolyte secondary battery in accordance with a conventional technology (comparison example);

FIG. 15 is a sectional view of a solid electrolyte secondary battery in accordance with Embodiment 2 of the present invention;

FIG. 16 is a sectional view of a solid electrolyte secondary battery in accordance with Embodiment 3 of the present invention;

FIG. 17 is a sectional view of a solid electrolyte secondary battery in accordance with Embodiment 4 of the present invention;

FIG. 18 is a sectional view of a solid electrolyte secondary battery in accordance with Embodiment 5 of the present invention;

FIG. 19 is a sectional view of a solid electrolyte secondary battery in accordance with Embodiment 6 of the present invention; and

FIG. 20 is a sectional view of a solid electrolyte secondary battery in accordance with Embodiment 9 of the present invention;

### BEST MODE FOR CARRYING OUT THE INVENTION

Embodiments of the present invention will be described below referring to the drawings.

(Embodiment 1)

FIGS. 1 to 13 are sectional views of a solid electrolyte secondary battery in accordance with Embodiment 1 at respective production processes. In the figures, a1 designates an alumina substrate, b designates a Cu film, c and c′ designate photoresist films, d designates a mask, e designates a light beam of a short wavelength, f designates a three-layer film comprising a positive-electrode active material layer, a solid electrolyte layer and a negative-electrode active material layer and serving as a power-generating element, g designates an Al film, h designates a SiO₂ film, j designates a lower current delivery terminal portion, k designates an upper current delivery terminal portion, and x designates a metal mask.

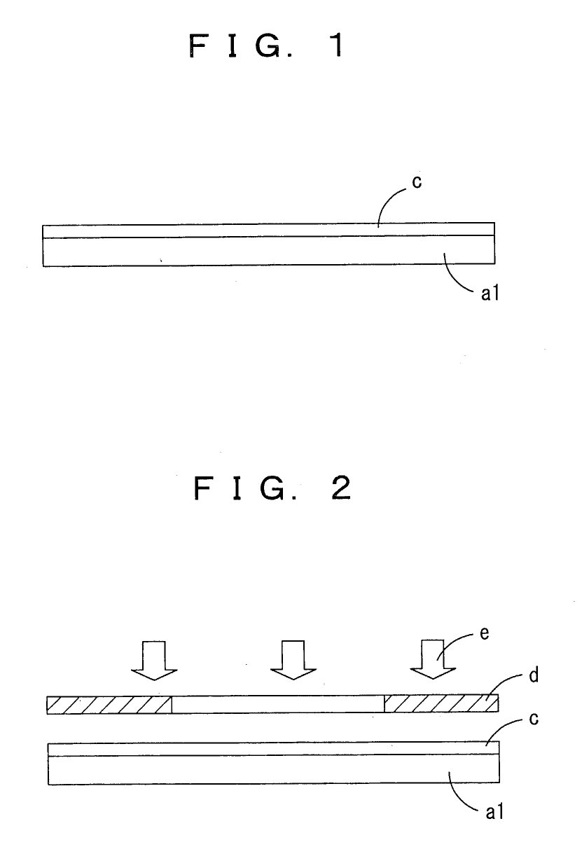

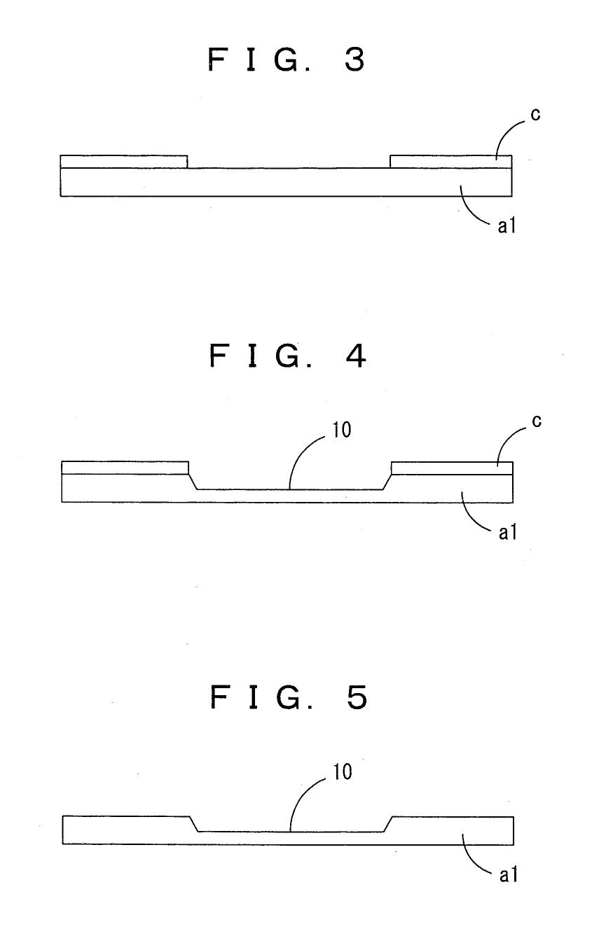

First, a photoresist was applied to an alumina (Al₂O₃) substrate a1 having a thickness of 1 mm by a spin coater so as to have a film thickness of several micrometers, and then baked at about 100° C., thereby forming a photoresist film c (FIG. 1). Next, as shown in FIG. 2, by using a mask d subjected to patterning so as to have a recessed shape (1 cm×1 cm), irradiation with a light beam e of a short wavelength was carried out by an aligner. Then, dipping in a developing solution was carried out, thereby completing the patterning of the photoresist film (FIG. 3). Next, by using the RF dry etching system, a portion of the alumina substrate a1 not coated with the photoresist film c was etched up to a depth of 0.3 μm. FIG. 4 shows a sectional view after the etching. In the end, the photoresist film c was removed with a removing solution (FIG. 5).

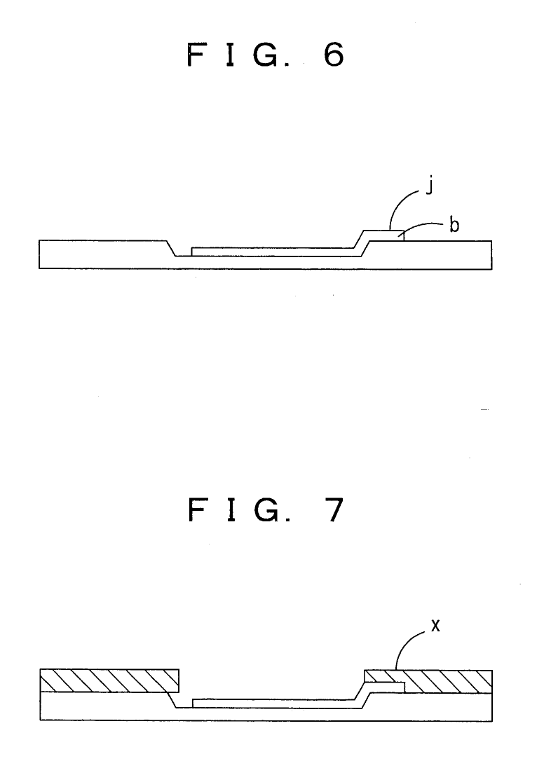

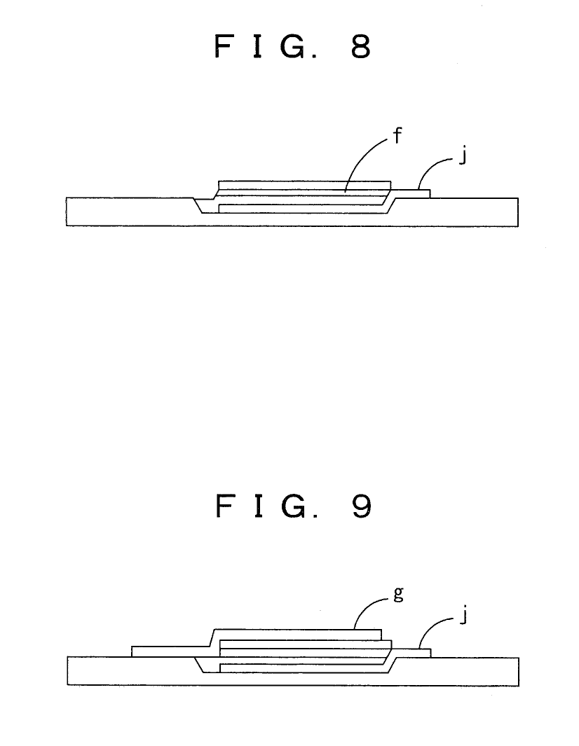

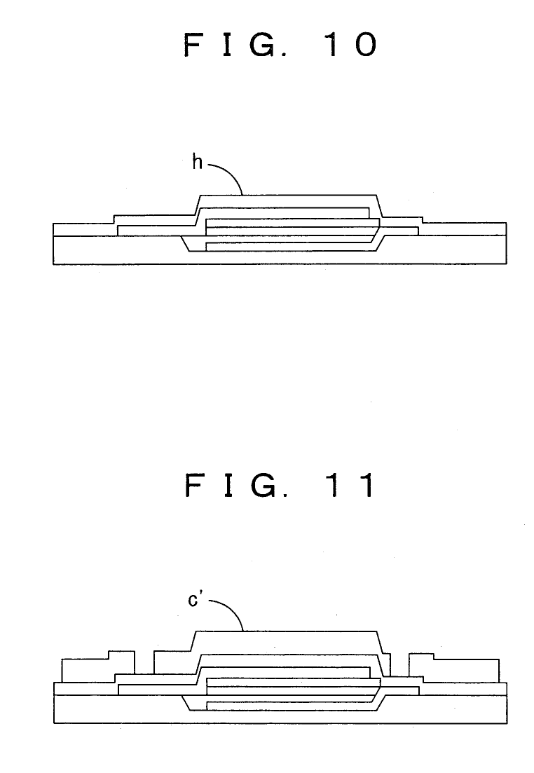

Next, in FIGS. 6 to 9, on the alumina substrate a1 in which this recessed portion 10 was formed, a Cu film b having a thickness of 0.2 μm was formed by the magnetron sputtering method (target: oxygen-free copper in ordinary conditions) (FIG. 6); a photoresist was applied to this film, whereby a current collector portion (0.9 cm×0.9 cm) and a negative-electrode current delivery terminal portion were formed on the bottom face of the recessed portion by the above-mentioned method as a photoresist film (film thickness: 2 μm). Next, the portion of the Cu film not coated with the photoresist film was etched by using the RF plasma etching system, and the photoresist film was removed with the removing solution in the end, whereby a lower metal current collector film and a lower current delivery terminal portion j were formed (FIG. 6). Next, a metal mask x having a window in the shape (1 cm×1 cm) of the negative electrode on the Cu film b having been subjected to patterning at the recessed portion was aligned with the recessed portion and fixed (FIG. 7); metal Li as a negative-electrode active material, Li₃PO₄₋ₓNₓ as a solid electrolyte and LiₓMn₂O₄ as a positive-electrode active material were formed in this order into films having 0.2 μm, 0.2 μm and 0.3 μm in thickness, respectively, in the same chamber by using the magnetron sputtering method, thereby forming a three-layer film f (FIG. 8). However, the cosputter method of hitting N₂ plasma against the surface of the substrate by using LiPO₄ as a target was used for Li₃PO₄₋ₓNₓ. Next, on this three-layer film f, a metal mask having a window in the shape of a square (0.85 cm×0.85 cm) slightly smaller than the shape of the three-layer film and having a window for a current delivery terminal portions was aligned and fixed, and then on this three-layer film f, an Al film g (film thickness: 0.3 μm) was formed only at the window portions by the electron beam vapor deposition method (FIG. 9).

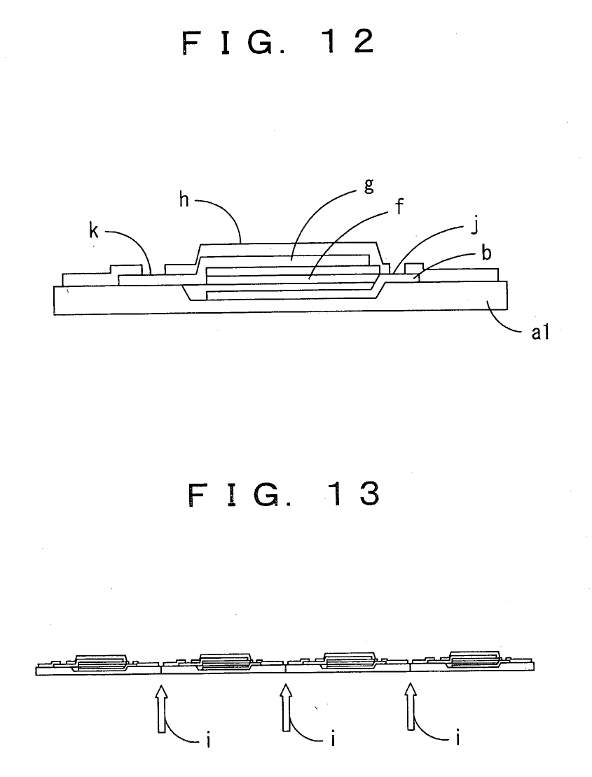

Next, as shown in FIG. 10, on this Al film g, a SiO₂ film (film thickness: 0.4 μm) was formed as a protective film (insulating film) h by the magnetron sputtering method. Next, portions other than the negative and positive electrode delivery terminal portions-of this silicon oxide film were coated with a photoresist c′ by using the above-mentioned patterning method (FIG. 11), and the SiO₂ films at the portions not coated with the photoresist film were dry-etched by using the CF₄ reactive ion etching (RIE) system. Then, the photoresist film was removed by the oxygen plasma ashing system (FIG. 12), whereby a solid electrolyte secondary battery was completed. Even if the photoresist film is not removed but left on the photoresist film at this time, no problem occurs.

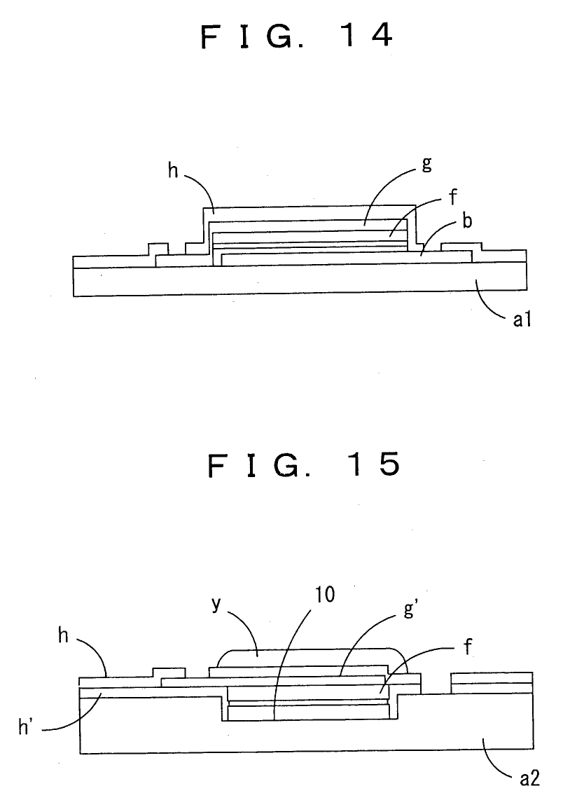

A plurality of the batteries can be formed on the alumina substrate a1, and can be cut at the cutting positions i as shown in FIG. 13, whereby individual batteries can be obtained. Instead of the alumina substrate, a ceramic substrate made of calcia or magnesia was able to be used.

The battery produced in this way has projection portions of only 0.6 μm on the substrate, and the battery was able to be charged and discharged normally; however, when a solid electrolyte secondary battery similar to that shown in FIG. 14 was configured by using an ordinary flat alumina substrate for comparison, projection portions of 0.9 μm from the surface of the substrate were formed, and wire breakage occurred at the current delivery terminal portion on the positive electrode side because of large steps, whereby charging and discharging were unable to be carried out in large quantity (in the comparison example). The symbols indicated in FIG. 14 and identical to those indicated in FIGS. 1 to 13 designate the same components having the same functions.

(Embodiment 2)

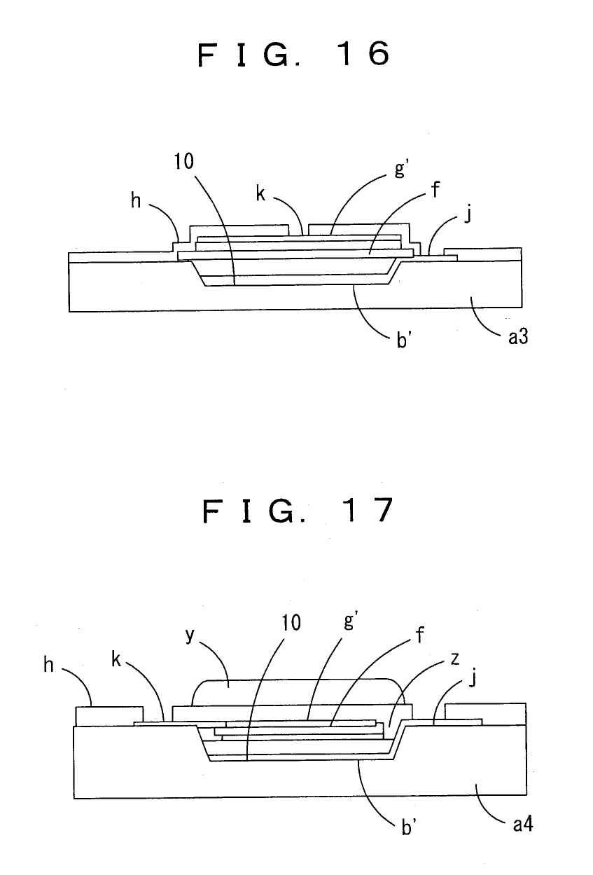

Embodiment 2 will be described referring to FIG. 15. By using a milling machine, a recessed portion 10 of 2 cm×2 cm (depth: 50 μm) was formed in an Al substrate a2 having a thickness of 1 mm by machining. After cleaning and drying, a stainless sheet (with an adhesive applied to the back side) was stuck to the bottom face of the recessed portion and the current delivery terminal portion, and an insulating film (SiOₓ) having a thickness of 1 μm was formed by the plasma CVD method so that portions (including the side walls of the recessed portion) other than the bottom face of the recessed portion and the current delivery terminal portion were coated with the insulating film, thereby forming an insulating layer h′. Next, after removing the stainless sheet from the bottom face of the recessed portion and the current delivery terminal portion, positive-electrode paste was applied to the bottom face of the recessed portion having no insulating film by screen printing by using a mesh having a pattern in the shape of the recessed portion. Herein, after 10 g of an acetylene black (AB) powder serving as an electrically conductive agent, 1 g of a Li₃PO₄—Li₂S—SiS₂ powder and 6 g of a polytetrafluoroethylene (PTFE) dispersion serving as a binding agent were mixed with 100 g of LiₓCoO₂, an appropriate amount of n-methyl-2-pyrrolidone (NMP) was added thereto and mixed sufficiently to obtain a paste-like substance, and this substance was used-as the positive-electrode paste. After the paste was dried, the paste was pressed to form a positive-electrode active material layer having a film thickness of 20 μm. Next, a solid electrolyte layer (film thickness: 5 μm) was formed on the positive-electrode active material layer by the screen printing method just as described above by using paste obtained by dispersing Li₃PO₄—Li₂S—SiS₂ in NMP. Next, a negative-electrode paste was printed and applied to the solid active material layer by the screen printing method just as described above. Herein, 15 g of an AB powder serving as an electrically conductive agent, 1 g of a Li₃PO₄—Li₂S—SiS₂ powder and 6 g of PTFE serving as a binding agent were mixed with 100 g of an artificial graphite powder, and an appropriate amount of NMP was added thereto and mixed sufficiently to obtain a paste-like substance, and this substance was used as the negative-electrode paste. After the paste was dried, the paste was pressed slightly to form a negative-electrode active material layer having a film thickness of 25 μm. In this way, a three-layer film f was formed.

Next, after the substrate was covered with a metal mask having windows in the shapes of the upper metal current collector and the current delivery terminal portion, a Cu film having a thickness of 0.5 μm was formed as a current collector g′ at a substrate temperature of 150° C. by the metal CVD method by using hexa-fluoro-acetyl-acetonate copper (1) trimethyl-vinyl-silance as a material. After removing the metal mask, a SiO₂ film having a thickness of 0.4 μm was formed as an insulating film h by the magnetron sputtering method, and portions other than the current delivery terminal portion were coated with a photoresist by the photo-lithography method just as in the case of Embodiment 1, and then the SiO₂ film at the portions not coated with the photoresist film was dry-etched by using CF₄ reactive gas and also by using RIE. After removing the photoresist by using the oxygen plasma ashing system, an epoxy resin serving as a sealing resin y mixed with silicon dioxide was applied to the recessed portion 10 to perform sealing, thereby completing a solid electrolyte secondary battery (FIG. 15).

The battery produced in this way had projection portions of only 0.5 μm on the substrate, and the battery was able to be charged and discharged normally without causing wire breakage.

As the method of forming the recessed portion, the sandblasting method was also effective as a machining method; furthermore, the recessed portion was also able to be formed by dipping into an alkaline aqueous solution, such as a KOH or NaOH aqueous solution, or a strong acidic aqueous solution, such as a HCl or HNO₃ aqueous solution, other than the machining method; still further, an electrolytic etching method of carrying out etching by applying a potential was also effective. Instead of the Al substrate, metal substrates made of Cu, Ni, Ti, stainless steel, etc. were also able to be used, although the order of lamination was changed slightly. In CVD, since the temperature of the substrate is usually required to be 250° C. or more, there is a high possibility of deteriorating the battery. However, in some types of films, such as a film made of Cu, film forming is possible at a relatively low substrate temperature (about 150° C.); it seems that the limit of the substrate temperature is about 200° C.

(Embodiment 3)

Embodiment 3 will be described referring to FIG. 16. Just as in the case of Embodiment 1, a photoresist layer was formed on a glass substrate a3 having a thickness of 1 mm at portions other than a recessed-portion forming portion by the photo-lithography method, and wet etching was carried out by using a HF aqueous solution, thereby forming a recessed portion 10 of 0.5 cm×0.5 cm×1 μm. Next, an Al film (film thickness: 0.2 μm) was formed on the substrate by using the metal CVD method, the bottom face of the recessed portion and the current delivery terminal portion were coated with a photoresist by using the photo-lithography method, unnecessary Al films were removed by using Cl₂ gas and also by using RIE, and the photoresist on the Al film was removed by using a special-purpose remover, thereby forming a lower metal current collector film b′ and a current delivery terminal portion j connected thereto. Next, a three-layer film f was formed. First, the recessed portion 10 was filled with a positive-electrode active material paste by using a doctor blade, and the paste was dried and pressed slightly to produce a positive electrode (film thickness: 0.8 μm). Herein, 15 g of an AB powder serving as an electrically conductive agent, 1 g of a Li₂O—B₂O₃ powder and 6 g of a PTFE dispersion serving as a binding agent were mixed with 100 g of LiₓNiO₂, and an appropriate amount of NMP was added thereto and mixed sufficiently to obtain a paste-like substance, and this substance was used as the positive electrode. As a solid electrolyte layer, a Li₂O—B₂O₃ film (film thickness: 0.2 μm) was formed on the substrate by using the magnetron sputtering system, and a photoresist pattern of 0.6 cm×0.6 cm was formed on the recessed portion 10 by the photo-lithography method, and then portions not coated with the photoresist were dry-etched by the ion milling method. The photoresist on the recessed portion was removed by the dry ashing method to form a solid electrolyte layer, and a FeSn alloy film serving as a negative-electrode active material layer and a Cu film serving as the upper metal current collector film g′ were formed continuously in the same chamber by the patterning method similar to that used for the solid electrolyte layer, that is, the magnetron sputtering method. As a result, a negative-electrode active material layer and an upper metal current collector layer, measuring 0.5 cm×0.5 cm (FeSn having a film thickness of 0.4 μm, Cu having a film thickness of 0.3 μm), were formed on the solid electrolyte layer. After an Al₂O₃ layer h having a thickness of 0.5 μm and serving as an insulating film h was formed thereon by the magnetron sputtering method, portions other than the lower and upper current delivery terminal portions j and k were coated with a photoresist by a method similar to that for the above-mentioned solid electrolyte layer, and the Al₂O₃ layer on the current delivery terminal portions was removed by the ion milling method, thereby completing a solid electrolyte secondary battery (FIG. 16).

The battery produced in this way has small steps on the substrate a3, whereby the battery was able to be charged and discharged normally without causing wire breakage.

(Embodiment 4)

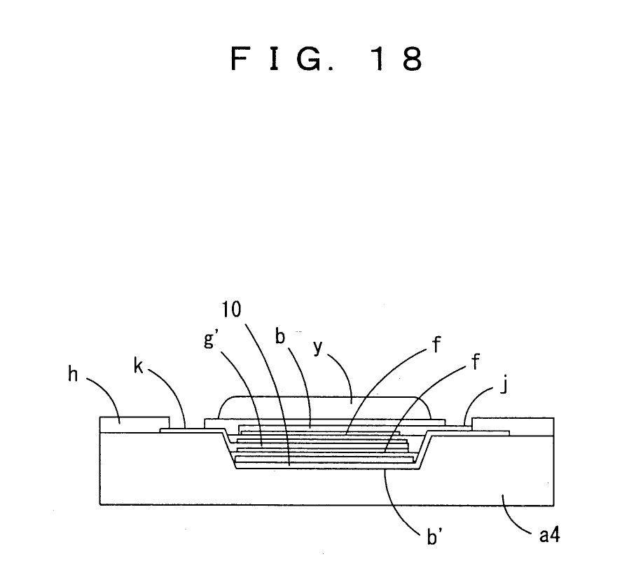

Embodiment 4 will be described referring to FIG. 17. By using a polyimide resin film a4 (thickness: 0.6 mm) as the substrate, a recessed portion 10 (1 cm×1 cm×3.7 μm) was formed by a method similar to that used for Embodiment 1, and a Ni film (film thickness: 0.3 μm) was formed by the electronic beam vapor deposition method, and then a lower current collector film b′ and a current delivery terminal portion j connected thereto were formed on the bottom face of the recessed portion by the RF dry etching system by using the above-mentioned patterning method. A metal mask having a window of 0.9 cm×0.9 cm was placed thereon to cover the recessed portion, and the negative-electrode layer (LiAl having a film thickness of 0.2 μm) and the solid electrolyte layer (LiN₃ having a film thickness of 0.3 μm) among the layers of a three-layer film f were formed simultaneously by the DC sputtering method, thereby forming the respective layers. After the gap between the recessed portion 10 and the layers was filled with an epoxy resin z, a metal mask having a window of 0.8 cm×0.8 cm and a window for the current delivery terminal portion was placed to cover the recessed portion, and a positive electrode layer (V₂O₅ having a film thickness of 1.5 μm) and a current collector film g′ (Al having a film thickness of 0.3 μm) were formed continuously by the magnetron sputtering method, and then a SiOₓ film having a thickness of 0.4 μm was formed as an insulating film h by the electronic beam vapor deposition method; after the insulating film on the current delivery terminal portions j and k was removed just as in the case of Embodiment 1, a vinyl ester resin was applied as a sealing resin y to the recessed portion 10, thereby completing a solid electrolyte secondary battery (FIG. 17).

The battery produced in this way has small steps on the substrate, whereby the battery was able to be charged and discharged normally without causing wire breakage.

Instead of applying the resin to the upper layer of the lower current delivery terminal portion formed on the side wall of the recessed portion, a method of forming a ceramic film by the sputtering method or the like and also forming an insulating film on the side walls of the recessed portion and necessary portions by the photo-lithography method was also effective.

(Embodiment 5)

Embodiment 5 will be described referring to FIG. 18. By using a polyimide resin film a4 (thickness: 0.6 mm) as the substrate, a recessed portion 10 (1 cm×1 cm×11 μm) was formed by a method similar to that used for Embodiment 1, and a Cu film (0.5 μm) was formed by the vacuum evaporation method (10 mTorr), and then a lower current collector film b′ and a current delivery terminal portion j connected thereto were formed on the bottom face of the recessed portion by the RF dry etching system by using the above-mentioned patterning method. A metal mask having a window of 0.9 cm×0.9 cm was placed thereon to cover the recessed portion, and among the layers of a three-layer film f, the negative electrode layer (Li having a film thickness of 1 μm) was first evaporated (10 mTorr) Next, a metal mask having a window of 1 cm×1 cm was placed thereon to cover the recessed portion, and sputtering (RF power of 100 W, 20 mTorr) was carried out in a N₂ atmosphere by using the Li₃PO₄ as a target, thereby forming the solid electrolyte layer (Li₃PO₄—XNX having a thickness of 2 μm). Furthermore, a metal mask having a window of 0.8 cm×0.8 cm was placed thereon to cover the recessed portion, and the positive electrode layer (LiCoO₂ having a thickness of 2 μm) was formed by the sputtering method. The sputtering conditions were 200 W, Ar/O₂=3/1 at 50 sccm, 10 mTorr. Furthermore, a metal mask having a window of 0.8 cm×0.8 cm and a window for the current delivery terminal portion was placed thereon to cover the recessed portion, and a current collector film g′ (Al having a film thickness of 0.5 μm) was formed by the vacuum evaporation method (10 mTorr). Next, the metal mask having a window of 0.8 cm×0.8 cm was placed again on the Al film to cover the recessed portion, and the positive electrode layer (LiCoO₂ having a thickness of 2 μm) was formed by the sputtering method in the same conditions as described above. Next, the metal mask having a window of 1 cm×1 cm was placed thereon again to cover the recessed portion, and sputtering (RF powder of 100 W, 20 mTorr) was carried out in a N₂ atmosphere by using the Li₃PO₄, as a target, thereby forming the solid electrolyte layer (Li₃PO₄—XNX having a thickness of 2 μm). Furthermore, a metal mask having a window of 0.7 cm×0.7 cm was placed thereon to cover the recessed portion, and evaporation (10 mTorr) was carried out to form the negative electrode layer (Li having a thickness of 1 μm). Next, the metal mask having a window of 0.8 cm×0.8 cm and a window for the current delivery terminal portion was placed thereon to cover the recessed portion, and a Cu film b (0.5 μm) was formed by the vacuum evaporation method (10 mTorr), and then a SiO₂ film having a thickness of 0.3 μm was formed as an insulating film h by the RF sputtering method; after the insulating film on the current delivery terminal portions j and k was removed just as in the case of Embodiment 1, a butyl rubber resin was applied as a sealing agent y to the recessed portion 10, thereby completing a solid electrolyte secondary battery.

In the battery produced as described above, since the etching depth of the substrate was made identical with the thickness of the battery, the step coverage for the wiring connected from the uppermost current collector to the current delivery terminal portions was able to be attained without problems, whereby a battery having high reliability was obtained, and charging and discharging were carried out normally. In addition, a battery capacity of 70 μAh was able to be obtained.

In addition, by using this embodiment, the depth of the recessed portion of the substrate and the step coverage for the wiring from the uppermost current collector to the current delivery terminals were examined, and the results were indicated in Table 1.

TABLE 1
The depth of the recessed portion of the substrate
and the step coverage for the wiring from the uppermost
current collector

| | | | | | | |
|---|---|---|---|---|---|---|
| Depth of recessed | 2.2 | 3.3 | 5.5 | 11.0 | 18.7 | 19.8 |
| portion (μm) | | | | | | |
| Depth of recessed | 0.2 | 0.3 | 0.5 | 1.0 | 1.7 | 1.8 |
| portion divided by | | | | | | |
| thickness of battery | | | | | | |
| Step coverage | x | ◯ | ◯ | ⊚ | ◯ | x |

Thickness of battery: 11 μm (excluding the thickness of the uppermost current collector)
X: breakage at the wiring portion
◯: no breakage at the wiring portion
⊚: no breakage at the wiring portion, the variation of the thickness of the wiring: within 10%

From the results, no problem occurred in the case when the depth of the recessed portion of the substrate was in the range of 0.3 to 1.7 times as large as the whole film thickness of the power-generating element (the film thickness from the lower metal current collector to the bottom of the upper metal current collector film). The range of 0.3 to 1.0 time as large as the whole film thickness was used as an actual specification value, since a volume increase occurred when the substrate was etched to a depth larger than the thickness of the power-generating element. In addition, it was also found that the variation of the thickness of the wiring portion was within 10% when the steps at the projection portions were about 0.6 μm or less. This was evaluated by using a separate test pattern to examine the thickness of the wiring portion depth the steps. In this evaluation, the depth of the recessed portion of the substrate was changed from 0.1 μm to 1 μm, Cu wiring (thickness: 0.5 μm) was carried out thereon, observation from the cross-section of the wiring portion was conducted by using SEM, and the results were shown (Table 2).

TABLE 2
The depth of the recessed portion of the substrate
and the step coverage for the Cu wiring (wiring thickness: 0.5 μm)

| | | | | | | |
|---|---|---|---|---|---|---|
| Depth of recessed | 0.1 | 0.3 | 0.5 | 0.6 | 0.7 | 1.0 |
| portion (μm) | | | | | | |
| Variation of | 0.45 | 0.45 | 0.45 | 0.45 | 0.40 | 0.20 |
| thickness of wiring | ˜ | ˜ | ˜ | ˜ | ˜ | ˜ |
| (μm) | 0.55 | 0.55 | 0.55 | 0.55 | 0.55 | 0.55 |

(Embodiment 6)

Embodiment 6 will be described referring to FIG. 19. Just as in the case of Embodiment 1, after the pattern (window) of a recessed portion was formed on a silicon substrate a5, the recessed portion (1 mm×1 mm×0.8 μm) was formed by RIE by using CF₄ gas, and a silicon nitrided film h′ (film thickness: 0.3 μm) was formed by the plasma CVD method (reactant gas: SiH₄—NH₃, substrate temperature: 200° C., pressure: 0.2 Torr). Next, a Cu film b having a thickness of 0.3 μm was formed as a current collector by the electron beam evaporation method, and the recessed portion and a current delivery terminal portion j were formed by the RF plasma etching method, just as in the case of Embodiment 1, and then a TiSn film (film thickness: 0.8 μm) was formed thereon by the electron beam evaporation method; after a photoresist pattern was formed on the recessed portion 10 by the photo-lithography method, a negative electrode measuring 1 mm×1 mm was formed by the RF plasma etching method. Next, a Li₃N—LiI—LiOH film (film thickness: 0.2 μm) (1.1 mm×1.1 mm) was formed as a solid electrolyte layer on the above-mentioned negative electrode by the magnetron sputtering method, just as the above-mentioned negative electrode was formed. After a Li_{3/4}Ti_{5/3}O₄ (film thickness: 0.3 μm) was formed thereon by the magnetron sputtering method, a positive electrode pattern measuring 1 mm×1 mm was formed by the RF plasma etching method, just as the above-mentioned negative electrode was formed. Hence, a three-layer film f was formed. After an Al film (film thickness: 0.3 μm) was formed thereon by the electron beam evaporation method, a current collector film g′ having a shape of a square measuring 0.9 mm×0.9 mm and a current delivery terminal portion k were formed on the positive electrode. An epoxy resin y was applied thereto, thereby completing a solid electrolyte secondary battery (FIG. 19).

In the case when the battery of this embodiment is formed on a semiconductor IC, a hybrid chip comprising an IC and a battery is obtained.

As solid electrolytes for Li ions, Li₂O—SiO₂, Li₂O—B₂O₃, LiI—Li₂S—P₂O₅, LiI—Li₂S—B₂S₃, Li_{3.6}Si_{0.6}P_{0.4}O₄, LiI—Li₃PO₄-P₂S₅, etc. were also effective.

(Embodiment 7)

A solid electrolyte secondary battery was produced by using Cu as the negative electrode, RbCuI_{1.5}Cl_{3.5} as the solid electrolyte and TiS₂ as the positive electrode, while the configuration (shape, film thickness and structure) and the production method of the battery were the same as those of Embodiment 1. Although the rate characteristic was lower in comparison with the Li-based battery of Embodiment 1, the reliability factors, such as cycle life, were equal.

As other Cu-based solid electrolytes, Rb₄Cu₁₆I₇Cl₁₃, Rb₄Cu₁₆I₇Cl₁₃, CuI—Cu₂O—MoO₃, etc. were also effective.

(Embodiment 8)

A solid electrolyte secondary battery was produced by using Ag as the negative electrode, Ag₆I₄WO₄ as the solid electrolyte and V₂O₅ as the positive electrode, while the configuration (shape, film thickness and structure) and the production method of the battery were the same as those of Embodiment 6. Although the rate characteristic was lower in comparison with the Li-based battery of Embodiment 1, the reliability factors, such as cycle life, were equal.

As other Ag-based solid electrolytes, AgI—Ag₂O—MoO₃, α-AgI, C₆H₅NHAg₅I₆, AgI—Ag₂O—B₂O₃, AgI—Ag₂O—V₂O₅, etc. were also effective.

(Embodiment 9)

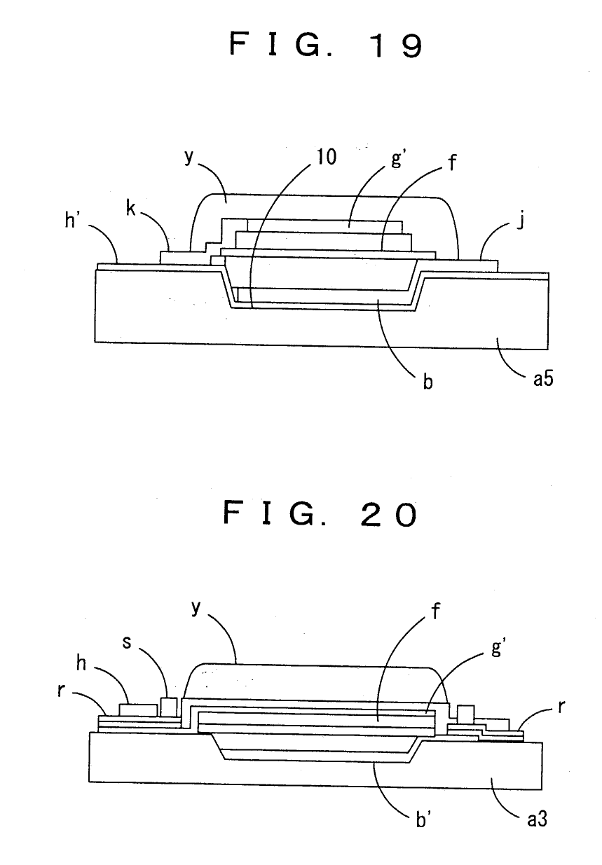

Embodiment 9 will be described referring to FIG. 20. After the Cu film of the upper metal current collector g′ was formed in Embodiment 3, a Ti film (film thickness: 0.2 μm) and an Au film (film thickness: 0.2 μm) were formed by the electron beam evaporation method, and the current delivery terminal portions and current terminals r for plating at both the electrodes were formed by the photo-lithography method and the dry etching method. Next, after an insulating film h and a sealing resin y were applied for coating by a method similar to that of Embodiment 3, electrolyte plating was carried out by using the current delivery terminal portions of the positive and negative electrodes as the cathode and by using the Au as the anode. Gold bumps s having a thickness of 20 μm were formed on the current delivery terminal portions of the power-generating element by using a solution of gold potassium cyanide (15 g/l) and acetic acid (100 g/l) as an electrolytic plating solution and by flowing a current of 3 A/dm² (FIG. 20). The battery having the bumps s as described above was able to be compatible with COB-mounting on a multilayer substrate and also compatible with TCP (Tape Carrier Package). A gold wire bonding method was also able to be used as a bump forming method.

(Embodiment 10)

A solid electrolyte primary battery comprising metal Li as the negative electrode, Li₃PO₄₋ₓNₓ as the solid electrolyte and graphite fluoride as the positive electrode was produced by carried out the magnetron sputtering method by using graphite fluoride as a positive electrode target, while the configuration (shape, film thickness and structure) and the production method of the battery were the same as those of Embodiment 1. The produced battery had a wider operation temperature range of −40° C. to 200° C., thereby being superior to the currently available coin-type graphite lithium fluoride battery (the operation temperature range: −40° C. to 150° C.) in high-temperature resistance and reliability.

As solid electrolytes for Li ions, Li₂O—SiO₂, Li₂O—B₂O₃, LiI—Li₂S—P₂O₅, LiI—Li₂S—B₂S₃, Li_{3.6}Si_{0.6}P_{0.4}O₄, LiI—Li₃PO₄-P₂S₅, etc. were also effective.

By forming the solid electrolyte secondary battery or the solid electrolyte primary battery on the recessed portion 10 of the substrate in accordance with the embodiments of the present invention, it is possible to provide a battery having smaller steps, being excellent in step coverage and being characterized by high reliability, low profile, compact size and high capacity. For the stability of the step coverage, it was effective that the depth of the recessed portion was preferably in the range of 0.3 to 1.0 time as large as the whole film thickness of the power-generating element (the thickness from the lower metal current collector layer to the bottom of the upper metal current collector film), and it was desirable that the steps on the surface of the substrate were limited to 0.6 μm or less.

Since the battery in accordance with the present invention is a solid electrolyte battery characterized by high reliability, low profile and compact size, the battery can be produced directly on IC substrates, and can also be compatible with high-density mounting, such as TCP and COB.

1. (Amended) A solid electrolyte battery comprising:
one of a metal substrate, a semiconductor substrate, a glass substrate, a ceramic substrate and a resin substrate, having a recessed portion and
one or more power-generating elements each having a first active material layer, a solid electrolyte layer and a second active material layer, wherein
said power-generating element is disposed in said recessed portion, and the depth of said recessed portion is in the range of 0.3 to 1.0 time as large as the whole film thickness of said laminated power-generating element.

2. (Deleted)

3. (Unchanged) A solid electrolyte battery in accordance with claim 1, wherein said power-generating element has an upper metal current collector film, and said upper metal current collector film is provided with a current delivery terminal portion.

4. (Unchanged) A solid electrolyte battery in accordance with claim 1, wherein said power-generating element has an upper metal current collector film, and said upper metal current collector film is coated with an insulating film.

5. (Unchanged) A solid electrolyte battery in accordance with claim 1, wherein the side wall of said recessed portion is coated with an insulating film.

6. (Unchanged) A solid electrolyte battery in accordance with claim 1, wherein said power-generating element has current delivery terminal portions comprising lower and upper metal current collector films, and metal bumps are formed on said current delivery terminal portions.

7. (Unchanged) A method of producing a solid electrolyte battery, comprising a recessed portion forming step of forming a recessed portion having a predetermined shape and a predetermined depth at a predetermined position on one of a metal substrate, a semiconductor substrate, a glass substrate, a ceramic substrate and a resin substrate, and a laminating step of sequentially laminating said power-generating element layers on said recessed portion.

8. (Unchanged) A method of producing a solid electrolyte battery in accordance with claim 7, wherein
in said recessed portion forming step, said substrate is a metal substrate, and said recessed portion having said predetermined shape and said predetermined depth is formed at said predetermined position on said metal substrate by machining, or formed by coating portions other than a recessed-portion forming portion with a photoresist by the photo-lithography method, by etching said metal substrate to said predetermined depth by the dry-etching method or the wet-etching method and by removing said photoresist, and
in said laminating step, an insulating film is formed on said substrate by one of film forming methods selected from the evaporation method, the sputtering method and the CVD method; said insulating film on portions other than the bottom face of said recessed portion and a current delivery window forming portion is coated with a photoresist; said insulating film on the bottom face of said recessed portion and said current delivery window forming portion is removed by the dry-etching method or the wet-etching method; said photoresist on said insulating film is removed to form an insulating layer; the first active material layer, the solid electrolyte layer and the second active material layer of a power-generating element are formed thereon at said recessed portion by one of film forming methods selected from the evaporation method and the sputtering method and by the patterning method carried out by the dry-etching method after photoresist coating; a metal film is further formed by one of film forming methods selected from the evaporation method, the sputtering method and the CVD method; and an upper metal current collector film is formed on said second active material layer by photoresist covering and dry-etching.

9. (Unchanged) A method of producing a solid electrolyte battery in accordance with claim 7, wherein
in said recessed portion forming step, said substrate is one of a semiconductor substrate, a glass substrate, a ceramic substrate and a resin substrate, and said recessed portion having said predetermined shape and said predetermined depth is formed at said predetermined position on said substrate by machining, or formed by coating portions other than a recessed-portion forming portion with a photoresist by the photo-lithography method, by etching said metal substrate to said predetermined depth by the dry-etching method or the wet-etching method and by removing said photoresist, and
in said laminating step, a metal film is formed on said substrate by one of film forming methods selected from the evaporation method, the sputtering method and the CVD method; the bottom face of said recessed portion and a current delivery terminal forming portion on said metal film are coated with a photoresist; unnecessary portions are removed by the dry-etching method or the wet-etching method to form a lower metal current collector film connected to a current delivery terminal portion; said photoresist is removed; the first active material layer, the solid electrolyte layer and the second active material layer of a power-generating element are formed on said lower metal current collector film by one of methods selected from the evaporation method and the sputtering method, by photoresist coating and by the dry-etching method; a metal film is further formed thereon by one of film forming methods selected from the evaporation method, the sputtering method and the CVD method; and an upper metal current collector film is formed by photoresist coating and the dry-etching method.

10. (Unchanged) A method of producing a solid electrolyte battery in accordance with claim 7, wherein
in said recessed portion forming step, said substrate is a semiconductor substrate or a resin substrate, and said recessed portion having said predetermined shape and said predetermined depth is formed at said predetermined position on said substrate by machining, or formed by coating portions other than a recessed-portion forming portion with a photoresist by the photo-lithography method, by etching said substrate to said predetermined depth by the dry-etching method or the wet-etching method, and by removing said photoresist, and
in said laminating step, an insulating film is formed on the whole face of said substrate by one of film forming methods selected from the evaporation method, the sputtering method and the CVD method; a metal film is formed on said substrate by one of film forming methods selected from the evaporation method, the sputtering method and the CVD method; the bottom face of said recessed portion and a current delivery terminal forming portion on said metal film are coated with a photoresist; unnecessary portions are removed by the dry-etching method or the wet-etching method to form a lower metal current collector film, on the bottom face of said recessed portion, connected to a current delivery terminal portion; the first active material layer, the solid electrolyte layer and the second active material layer of a power-generating element are formed on said lower metal current collector film by one of methods selected from the evaporation method and the sputtering method, by photoresist coating and by the dry-etching method; a metal film is further formed thereon by one of film forming methods selected from the evaporation method, the sputtering method and the CVD method; and an upper metal current collector film is formed by photoresist coating and the dry-etching method.

11. (Unchanged) A method of producing a solid electrolyte battery in accordance with claim 8, wherein, when said insulating layer is formed on said substrate, a metal sheet or a resin film is stuck to the bottom face of said recessed portion and said current delivery terminal portion, an insulating film is formed by one of film forming methods selected from the evaporation method, the sputtering method and the CVD method, and said metal sheet or said resin film is removed, thereby forming said insulating film.

12. (Unchanged) A method of producing a solid electrolyte battery in accordance with claim 9 or 10, wherein coating is carried out by applying a resin to said current delivery terminal portion connected to said lower metal current collector on the side wall of said recessed portion, or by forming a ceramic insulating film by the evaporation method, the sputtering method or the CVD method and then by patterning.

13. (Unchanged) A method of producing a solid electrolyte battery in accordance with claim 12, 9 or 10, wherein a plurality of layers are formed continuously in the same chamber.

14. (Unchanged) A method of producing a solid electrolyte battery in accordance with claim 8, 9 or 10, wherein the pattern of each layer is formed by covering said substrate with a metal mask having windows at necessary portions.
